(19) United States
(12) Patent Application Publication
(10) Pub. No.: US 2025/0193099 A1
(43) Pub. Date: Jun. 12, 2025

(54) NETWORK MONITORING DEVICE, NETWORK MONITORING SYSTEM, NETWORK MONITORING METHOD, AND RECORDING MEDIUM

(71) Applicant: NEC Corporation, Minato-ku, Tokyo (JP)

(72) Inventors: Noboru NAGATANI, Tokyo (JP); Tomoo ADACHI, Tokyo (JP); Shuichi KARINO, Tokyo (JP)

(73) Assignee: NEC Corporation, Minato-ku, Tokyo (JP)

(21) Appl. No.: 18/851,463

(22) PCT Filed: Mar. 31, 2022
(86) PCT No.: PCT/JP2022/016399

§ 371 Date: Sep. 26, 2024

(51) Int. Cl. H04L 43/0817; H04L 43/065

(52) U.S. Cl. CPC H04L 43/0817; H04L 43/065

(57) ABSTRACT

A network monitoring device according to the present disclosure comprises an inoperativeness detecting means that detects that a network device being monitored has become inoperative, and a task indication means that indicates, to the network device that has become inoperative, a task including console connection to a management terminal.

### TECHNICAL FIELD

The present disclosure relates to a network monitoring device, a network monitoring system, a network monitoring method, and a recording medium.

### BACKGROUND ART

There is a technique of remotely monitoring occurrence of abnormality of a device by console output information.

For example, PTL 1 discloses a monitoring device that constantly monitors console output information output from an electronic computer to be displayed on a console, detects an abnormality from the console output information, and notifies a monitoring center of occurrence of the abnormality.

### CITATION LIST

### Patent Literature

PTL 1: JP H05-282180 A

### SUMMARY OF INVENTION

### Technical Problem

However, in order to monitor the console output information, it is necessary to always connect the network device being monitored and the management terminal by a console cable, and the management of the wiring of the network device becomes complicated.

An object of the present disclosure is to provide a network monitoring device capable of detecting an abnormality occurring in a network device even in a state where console output information of the network device is not monitored.

### Solution to Problem

A network monitoring device according to an aspect of the present disclosure includes an inoperativeness detecting means for detecting that a network device being monitored has been brought into an inoperative state, and a task instruction means for instructing, to the network device in an inoperative state, a task including console connection to a management terminal.

A network monitoring system according to an aspect of the present disclosure is a network monitoring system including a management terminal that is connected to a network device in an inoperative state via a console, and the network monitoring device described above, in which the network monitoring device further includes an abnormality detection means for detecting abnormality information indicating an abnormality of firmware in console output information output from the network device.

A network monitoring method according to an aspect of the present disclosure causes a computer to execute detecting that a network device being monitored has been brought into an inoperative state, and instructing, to the network device in an inoperative state, a task including console connection to a management terminal.

A recording medium according to one aspect of the present disclosure stores a program for causing a computer to execute detecting that a network device being monitored has been brought into an inoperative state, and instructing, to the network device in an inoperative state, a task including console connection to a management terminal.

### Advantageous Effects of Invention

An example of an effect of the present disclosure is to provide a network monitoring device capable of detecting an abnormality occurring in a network device even in a state where console output information of the network device is not monitored.

### BRIEF DESCRIPTION OF DRAWINGS

FIG. 1 is a block diagram illustrating a configuration of a network monitoring device according to a first example embodiment.

FIG. 2 is a diagram illustrating a hardware configuration in which a network monitoring device according to the first example embodiment is implemented by a computer device and its peripheral devices.

FIG. 3 is an example of a task instruction output by a task instruction unit in the first example embodiment.

FIG. 4 is another example of the task instruction output by the task instruction unit in the first example embodiment.

FIG. 5 is a flowchart illustrating an operation of the network monitoring device according to the first example embodiment.

FIG. 6 is a block diagram illustrating a configuration of a network monitoring system according to a second example embodiment.

FIG. 7 is a flowchart illustrating an operation of a network monitoring system according to the second example embodiment.

### EXAMPLE EMBODIMENT

Next, example embodiments will be described in detail with reference to the drawings.

### First Example Embodiment

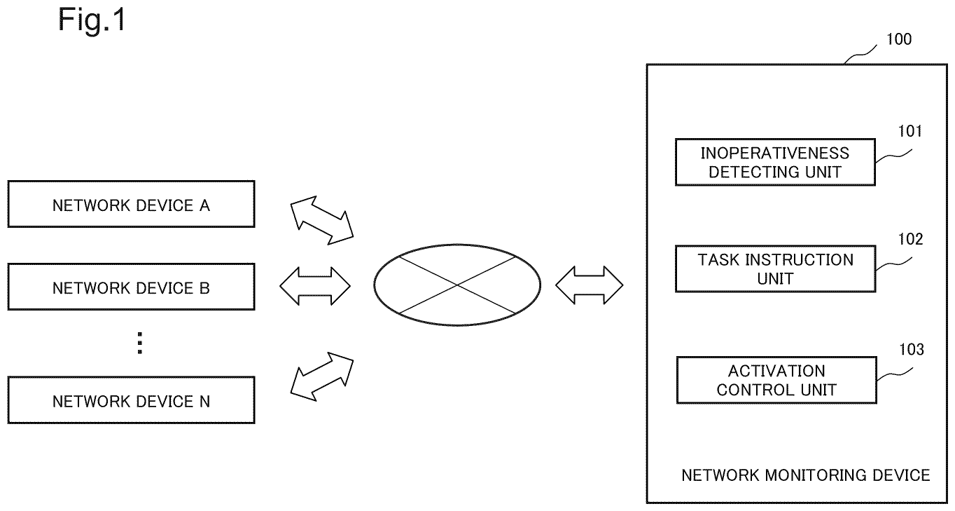

FIG. 1 is a block diagram illustrating a configuration of the network monitoring device 100 according to a first example embodiment. Referring to FIG. 1, the network monitoring device 100 is connected to a network device being monitored via a network. In the present example embodiment, the network device is a device for relaying or transferring data on a network such as a router, a hub, a gateway, or a switch. The number of network devices being monitored is not particularly limited. The network monitoring device 100 includes an inoperativeness detecting unit 101, a task instruction unit 102, and an activation control unit 103. However, in the present example embodiment, the activation control unit 103 is not an essential component.

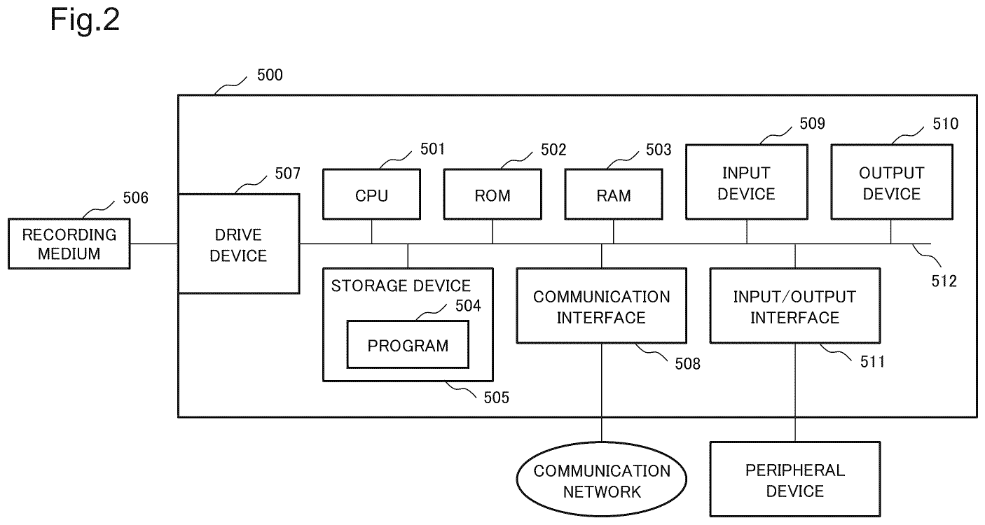

FIG. 2 is a diagram illustrating an example of a hardware configuration in which the network monitoring device 100 according to the first example embodiment of the present disclosure is achieved by a computer device 500 including a processor. As illustrated in FIG. 2, the network monitoring device 100 includes a central processing unit (CPU) 501, a memory such as a read only memory (ROM) 502 and a random access memory (RAM) 503, a storage device 505 such as a hard disk that stores a program 504, a communication interface 508 for network connection, and an input/output interface 511 that inputs and outputs data.

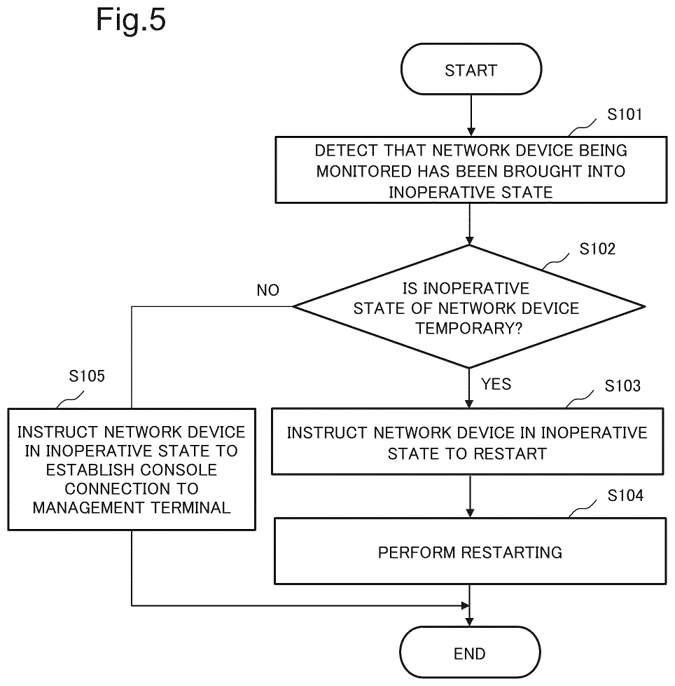

The CPU 501 controls the entire network monitoring device 100 according to the first example embodiment of the present invention by operating an operating system The CPU 501 reads a program and data from a recording medium 506 mounted on, for example, a drive device 507 to a memory. The CPU 501 functions as the inoperativeness detecting unit 101, the task instruction unit 102, the activation control unit 103, and a part thereof in the first example embodiment, and executes processing or a command in the flowchart illustrated in FIG. 5 to be described later based on a program.

The recording medium 506 is, for example, an optical disk, a flexible disk, a magnetic optical disk, an external hard disk, a semiconductor memory, or the like. A part of the recording medium of the storage device is a non-volatile storage device, and records a program in the part. The program may be downloaded from an external computer (not illustrated) connected to a communication network.

An input device 509 is achieved by, for example, a mouse, a keyboard, a built-in key button, and the like, and is used for an input operation. The input device 509 is not limited to a mouse, a keyboard, and a built-in key button, and may be, for example, a touch panel. An output device 510 is achieved by, for example, a display, and is used to confirm an output.

As described above, the first example embodiment illustrated in FIG. 1 is implemented by the computer hardware illustrated in FIG. 2. However, the means for implementing each unit included in the network monitoring device 100 of FIG. 1 is not limited to the configuration described above. The network monitoring device 100 may be implemented by one physically coupled device, or may be implemented by a plurality of devices by connecting two or more physically separated devices in a wired or wireless manner. For example, the input device 509 and the output device 510 may be connected to the computer device 500 via a network. The network monitoring device 100 according to the first example embodiment illustrated in FIG. 1 can be configured by cloud computing or the like.

In FIG. 1, the inoperativeness detecting unit 101 is a means for detecting that the network device being monitored has been brought into the inoperative state. The inoperative state is a state in which the network device does not operate normally due to a failure of a component, a defect of software, a resource shortage of the network device, or the like. Various methods can be used as a method for detecting that the inoperativeness detecting unit 101 has been brought into the inoperative state of the network device. For example, the inoperativeness detecting unit 101 may perform detection based on information regarding an operation state such as power consumption of the network device, a usage rate of the CPU or the memory, or may perform detection by periodically transmitting a specific command such as Ping to the network device and checking the presence or absence of a response. When detecting the inoperative state, the inoperativeness detecting unit 101 outputs information for specifying the network device in the inoperative state to the task instruction unit 102.

The task instruction unit 102 is a means for instructing the network device to perform task including console connection to the management terminal when detecting the inoperative state. In the present example embodiment, the console connection means that a console cable such as a serial cable is connected to a console port of the network device and is connected to the management terminal. When information for specifying the network device in the inoperative state is input from the inoperativeness detecting unit 101, the task instruction unit 102 outputs task content to be performed on the network device to the output device 510 or the like. The task instruction unit 102 instructs, for example, the network device to perform console connection of the monitoring device. The task instruction unit 102 may instruct to restart the network device.

The task instruction unit 102 may select a task to be instructed to the network device based on the log information of the network device immediately before being into the inoperative state. For example, when determining that the inoperative state of the network device is temporary based on the log information of the immediately preceding network device, the task instruction unit 102 instructs to restart the network device. The inoperative state being temporary is, for example, a state in which the inoperative state is considered to be restored by turning on the power supply again such as memory exhaustion, or a state in which a temperature abnormality occurs due to temporary stop of air conditioning.

More specifically, the task instruction unit 102 acquires the log information of the network device immediately before being into the inoperative state, obtained from a log collection means such as a syslog or a Simple Network Management Protocol (SNMP). Then, for example, when the log information includes log information of memory exhaustion of the network device, the task instruction unit 102 determines that the inoperative state of the network device is temporary, and instructs to restart the network device. When the inoperative state of the network device cannot be determined to be temporary based on the log information of the immediately preceding network device, the task instruction unit 102 instructs the network device in the inoperative state to establish console connection to the management terminal.

The activation control unit 103 is a means for controlling the power supply of the network device. For example, when the task instruction unit 102 instructs the network device in the inoperative state to restart, the activation control unit 103 restarts the network device.

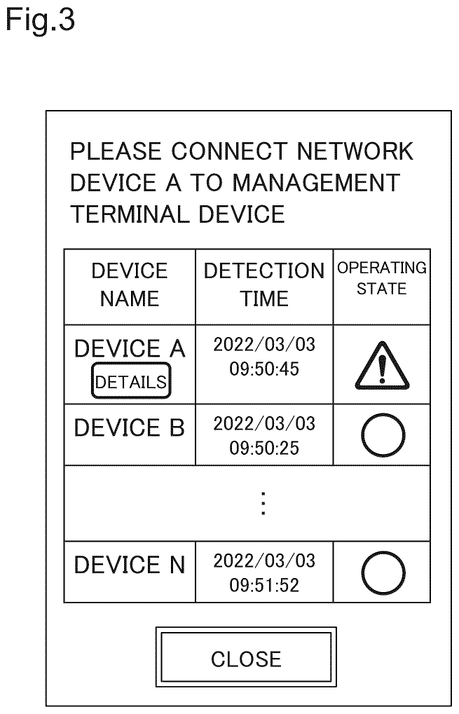

FIG. 3 is an example of a task instruction output by the task instruction unit 102 in the first example embodiment. As illustrated in FIG. 3, the task instruction unit 102 displays the network device name, the detection time when the operating state is detected, and the operating state. In FIG. 3, a device A is in an inoperative state, and devices B and N are in an operating state. As illustrated in the example of FIG. 3, when detecting that a button for displaying detailed information on the operating state is pressed, the task instruction unit 102 may display log information or the like immediately before the inoperative state.

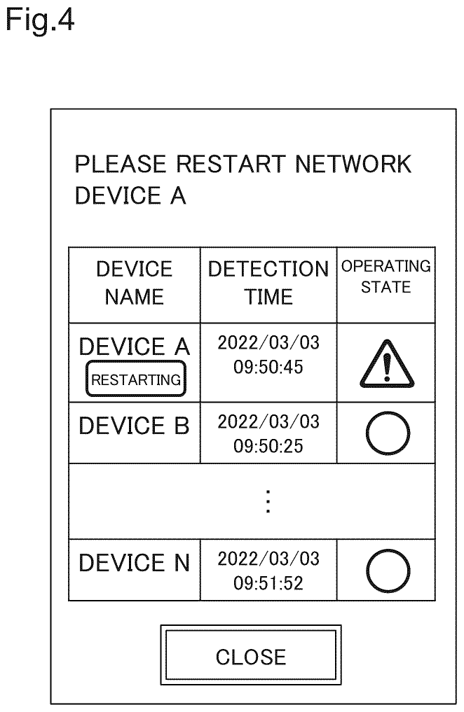

FIG. 4 is another example of the task instruction output by the task instruction unit 102 in the first example embodiment. When detecting that the restart button in FIG. 4 is pressed, the activation control unit 103 may restart the network device in the inoperative state.

The operation of the network monitoring device 100 configured as described above will be described with reference to the flowchart of FIG. 5.

FIG. 5 is a flowchart illustrating an outline of an operation of the network monitoring device 100 according to the first example embodiment. The processing according to this flowchart may be executed based on program control by the processor described above.

As illustrated in FIG. 5, first, the inoperativeness detecting unit 101 detects that the network device being monitored has been brought into the inoperative state (step S101). Next, the task instruction unit 102 determines whether the inoperative state of the network device is temporary based on the log information of the network device immediately before being into the inoperative state (step S102). When the task instruction unit 102 determines that the inoperative state of the network device is temporary (S102; YES) to instruct the network device in the inoperative state to restart (step S103), and the activation control unit 103 executes the restart (step S104). On the other hand, when the task instruction unit 102 does not determine that the inoperative state of the network device is temporary (step S102; NO), the task instruction unit instructs the network device in the inoperative state to establish console connection to the management terminal (step S105). The network monitoring device 100 repeats the processing according to this flowchart every time an inoperative state of any of the network devices is detected. Thus, the network monitoring device 100 terminates the operation.

In the network monitoring device 100 according to the first example embodiment, when detecting the inoperative state of the network device, the task instruction unit 102 instructs the network device in the inoperative state to perform work including console connection to the management terminal. As a result, even in a state where the console output information of the network device is not monitored, it is possible to detect an abnormality occurring in the network device. In a configuration in which the network monitoring device 100 does not include the activation control unit 103, when the task instruction unit 102 instructs the network device in the inoperative state to restart, the administrator operates the power switch of the network device to execute the restart.

### Second Example Embodiment

Next, a second example embodiment of the present disclosure will be described in detail with reference to the drawings. Hereinafter, description of contents overlapping with the above description will be omitted to the extent that the description of the present example embodiment is not unclear. In the second example embodiment, a scene after the network device is activated in a state where the network device in the inoperative state is connected to a management terminal 210 via the console is assumed.

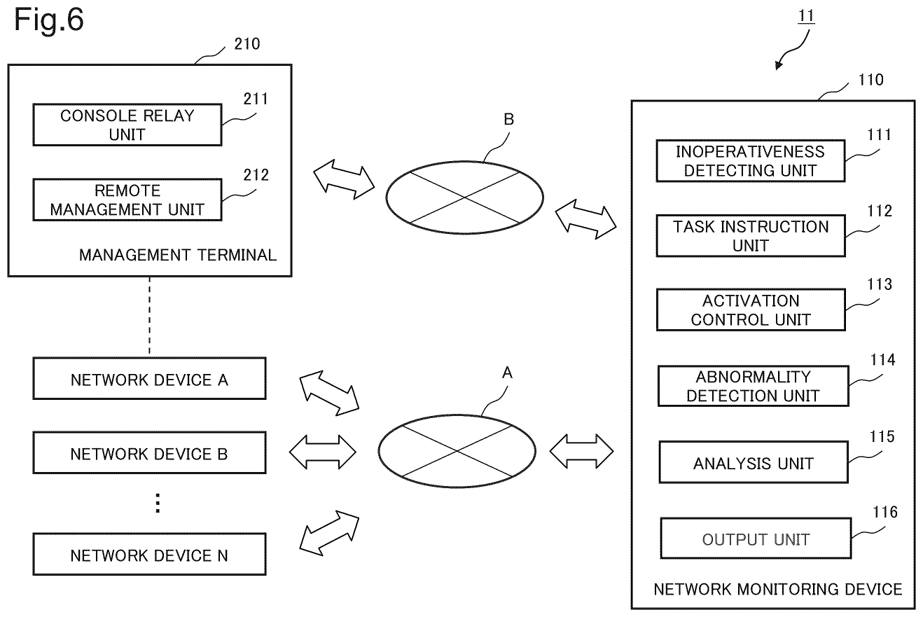

FIG. 6 is a block diagram illustrating a configuration of a network monitoring system 11 according to a second example embodiment. Referring to FIG. 6, the network monitoring system 11 includes a network monitoring device 110 connected to a network device being monitored via a business network A, and a management terminal 210 connected to the network monitoring device 110 via a management network B. The network device A in the inoperative state and the management terminal 210 are connected by a console cable such as a serial cable.

Similarly to the computer device illustrated in FIG. 2, each component of the network monitoring device 110 and the management terminal 210 in each example embodiment of the present disclosure can be achieved not only by hardware but also by a computer device or software based on program control.

The management terminal 210 in the present example embodiment is, for example, a portable terminal device such as a notebook PC. The management terminal 210 is not configured to always relay the console output of the network device even in the stationary type, and may be a device having a function of relaying the console output of the network device to the network by an operation of an administrator or a monitoring device. The administrator of the network device can grasp abnormality or falsification of firmware or the like of the network device A by displaying the console output information of the network device A output to the management terminal 210 on an output device such as a display. In the present example embodiment, the management terminal 210 transmits the console output information of the network device A to the network monitoring device 110 via the management network B.

In the present example embodiment, it is assumed that after an instruction is given by the configuration of the network monitoring device 100 according to the first example embodiment to establish console connection of the network device A with the management terminal 210, the administrator establishes console connection of the network device A with the management terminal 210. When the network device A fails to be activated in a state where the network device A is connected to the management terminal 210 via the console, log information indicating that the console output information fails is output in a case where the cause of the failure is not an abnormality caused by a power supply or the like. In particular, in a case where abnormality or falsification of firmware or the like is detected at the time of activation, information regarding the abnormality is output to the console output information, and an operation is performed in which the firmware is not read or executed.

### Network Monitoring Device 110

Referring back to FIG. 6, the network monitoring device 110 of the network monitoring system 11 according to the second example embodiment will be described focusing on portions different from those of the network monitoring device 100 according to the first example embodiment. The network monitoring device 110 includes an inoperativeness detecting unit 111, a task instruction unit 112, an activation control unit 113, an abnormality detection unit 114, an analysis unit 115, and an output unit 116. Since the inoperativeness detecting unit 111, the task instruction unit 112, and the activation control unit 113 are similar to the inoperativeness detecting unit 101, the task instruction unit 102, and the activation control unit 103 of the first example embodiment, respectively, the description thereof will be omitted.

The abnormality detection unit 114 is a means for detecting abnormality information indicating an abnormality of the firmware from the console output information output from the network device. The abnormality detection unit 114 detects an abnormality in the firmware based on whether the console output information includes, for example, a character string indicating that the activation has failed. When detecting an abnormality in the firmware, the abnormality detection unit 114 outputs a signal indicating the abnormality to the analysis unit 115.

The analysis unit 115 is a means for analyzing a portion indicating an abnormality cause of the console output information when the console output information includes abnormality information. The portion indicating the abnormality cause is, for example, a portion indicating a reason why the network device A has not read or executed the firmware. When the abnormality detection unit 114 detects an abnormality in the firmware, the analysis unit 115 analyzes a portion indicating the abnormality cause. In a case where the portion indicating the abnormality cause is a character string, the analysis unit 115 analyzes the abnormality cause by collating with a character string to be collated held in advance. Examples of the character string to be collated include a character string indicating that the electronic signature of the firmware does not match.

When the portion indicating the abnormality cause is a measurement value, the analysis unit 115 extracts the measurement value. The measurement value is a value obtained by calculating states of the network device, the program, and the data or configurations thereof with characters and numerical values at the time of activation of the network device, and is, for example, a hash value of firmware. The network monitoring system 11 holds, in the storage device 505, character strings that appear before and after the console output information, for example, in order to extract a description portion of the measurement value of the console output information. The analysis unit 115 collates the same character string with the console output information, identifies the position of the measurement value, and extracts the measurement value. In a case where a normal measurement value is held in advance in the storage device 505, the analysis unit 115 may collate the normal value with the measurement value. In a case where the measurement value is abnormal in the console output information, for example, if the measurement value is a hash value of the firmware, falsification of the firmware can be detected. If the measurement value is other than the hash value of the firmware, for example, it is also possible to detect that a portion other than the firmware, such as a setting file of the network device, has been falsified with when the network device is activated due to an abnormality (such as replacing some components) in the main body of the network device.

The output unit 116 is a means for outputting an analysis result by the analysis unit 115 to the output device 510 and the like. The output unit 116 outputs the abnormality cause when the portion indicating the abnormality cause is a character string. For example, in a case where the electronic signatures of the firmware do not match, the output unit 116 outputs an analysis result indicating that the electronic signatures do not match. The output unit 116 outputs the extracted measurement value when the portion indicating the abnormality cause is the measurement value. In a case where the normal value and the measurement value are collated, the output unit 116 may output the collated result.

### Management Terminal 210

The management terminal 210 includes a console port, a console relay unit 211 that relays network connection to the network monitoring device 110, and a remote management unit 212 having at least one of the functions of the task instruction unit 112, the abnormality detection unit 114, the analysis unit 115, or the output unit 116 in the network monitoring device 110.

In a case where the function of the task instruction unit 112 is provided, the remote management unit 212 outputs an instruction of work to be performed on the network device in the inoperative state to the output device 510 of the management terminal 210. In a case where the remote management unit 212 has the function of the abnormality detection unit 114 or the analysis unit 115, the remote management unit analyzes the console output information of the network device in the inoperative state on the management terminal 210. In a case where the function of the output unit 116 is provided, the remote management unit 212 outputs the analysis result by the analysis unit 115 to the output device 510 of the management terminal 210.

Furthermore, the remote management unit 212 may be connected to the network monitoring device 110 to control the activation control unit 113 of the network monitoring device 110. When any of the network devices being monitored is brought into the inoperative state, the administrator needs to go to the place of the network device in the inoperative state and establish console connection to the management terminal 210. Therefore, by allowing the management terminal 210 to have or control the functions of these components, the administrator can work in the vicinity of the network device in the inoperative state.

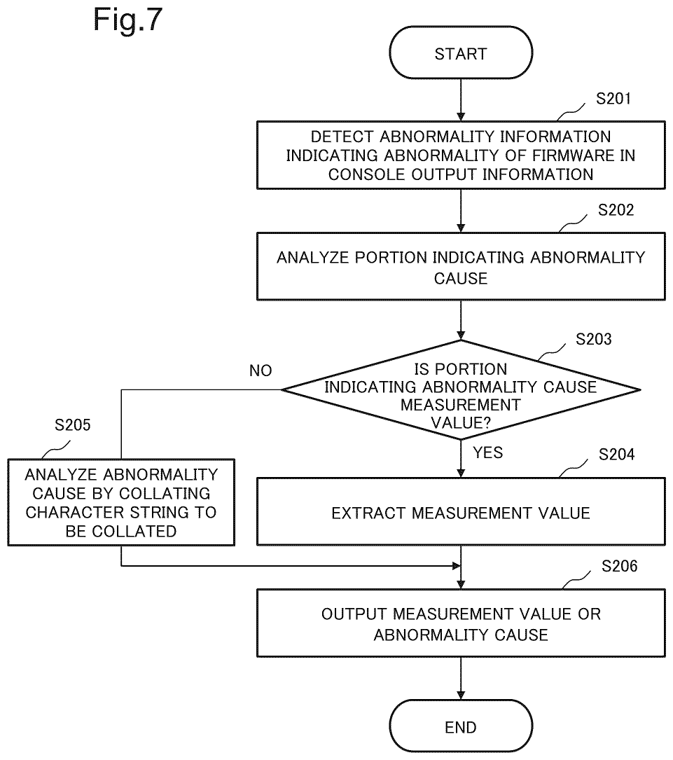

The operation of the network monitoring system 11 configured as described above will be described with reference to the flowchart of FIG. 7. FIG. 7 is a flowchart illustrating an outline of an operation of the network monitoring system 11 according to the second example embodiment. The processing according to this flowchart may be executed based on program control by the processor described above. This flowchart assumes a scene after the administrator causes the network device to restart after connecting the network monitoring device 110 in the inoperative state and the management terminal 210 by the console cable.

As illustrated in FIG. 7, first, the abnormality detection unit 114 detects abnormality information indicating an abnormality of firmware from the console output information of the network device in the inoperative state (step S201). Next, the analysis unit 115 analyzes a portion indicating the abnormality cause in the console output information (step S202). When the portion indicating the abnormality cause is the measurement value (step S203; YES), the analysis unit 115 extracts the measurement value of the abnormal portion (step S204). When the portion indicating the abnormality cause is a character string (step S203; NO), the analysis unit 115 collates the character string to be collated to analyze the abnormality cause (step S205). Finally, the measurement value extracted by the output unit 116 or the abnormality cause is output (step S206). Thus, the network monitoring system 11 terminates the operation.

In the network monitoring system 11 according to the second example embodiment of the present disclosure, the analysis unit 115 analyzes a portion indicating the abnormality cause based on the console output information. As a result, the administrator can grasp the abnormality cause of the network device.

Although the present invention has been described with reference to each example embodiment, the present invention is not limited to the above example embodiments. Various modifications that can be understood by those of ordinary skill in the art can be made to the configuration and details of the present invention within the scope of the present invention.

For example, although the plurality of operations is described in order in the form of a flowchart, the order of description does not limit the order of executing the plurality of operations. Therefore, when each example embodiment is implemented, the order of the plurality of operations can be changed within a range that does not interfere with the content. In the present example embodiment, the remote management unit 212 in the management terminal 210 may have the function of the inoperativeness detecting unit 111. However, in this case, the management terminal 210 needs to be network-connected to the network device being monitored.

### REFERENCE SIGNS LIST

11 network monitoring system
100, 110 network monitoring device
101, 111 inoperativeness detecting unit
102, 112 task instruction unit
103, 113 activation control unit
114 abnormality detection unit
115 analysis unit
116 output unit
210 management terminal
212 remote management unit

What is claimed is:

1. A network monitoring device comprising:
a first memory storing instructions; and
at least one first processor configured to execute the instructions to:
detect that a network device being monitored has been brought into an inoperative state; and
instruct, to the network device in an inoperative state, a task including console connection to a management terminal.

2. The network monitoring device according to claim 1, wherein the at least one first processor is further configured to execute the instructions to:
select a task to be instructed to the network device based on log information of the network device immediately before being into an inoperative state.

3. The network monitoring device according to claim 1, wherein the at least one first processor is further configured to execute the instructions to:
instruct the network device to perform work of console connection to a management terminal.

4. A network monitoring system comprising:
a management terminal that is connected to the network device in an inoperative state via a console; and
the network monitoring device according to claim 1, wherein the at least one first processor is further configured to execute the instructions to:
detect abnormality information indicating an abnormality of firmware from console output information output from the network device.

5. The network monitoring system according to claim 4, wherein the at least one first processor is further configured to execute the instructions to:
analyze a portion indicating an abnormality cause of the console output information in a case where the abnormality information is included in the console output information; and
output an analysis result of a portion indicating the abnormality cause.

6. The network monitoring system according to claim 5, wherein the at least one first processor is further configured to execute the instructions to:
analyze the abnormality cause by collating with a character string to be collated held in advance in a case where a portion indicating the abnormality cause is a character string, and
output the abnormality cause.

7. The network monitoring system according to claim 5, wherein the at least one first processor is further configured to execute the instructions to:
extract a measurement value of an abnormal portion in a case where a portion indicating the abnormality cause is a measurement value, and
output the extracted measurement value.

8. The network monitoring system according to claim 5, wherein
the management terminal comprising:
a second memory storing instructions; and
at least one second processor configured to execute the instructions to:
instruct, to the network device in an inoperative state, a task including console connection to a management terminal by remote management.

9. A network monitoring method causing a computer to execute:
detecting that a network device being monitored has been brought into an inoperative state; and
instructing, to the network device in an inoperative state, a task including console connection to a management terminal.

10. A non-transitory recording medium storing a program for causing a computer to execute:
detecting that a network device being monitored has been brought into an inoperative state; and
instructing, to the network device in an inoperative state, a task including console connection to a management terminal.

11. The network monitoring system according to claim 5, wherein
the management terminal comprising:
a second memory storing instructions; and
at least one second processor configured to execute the instructions to:
detect abnormality information indicating an abnormality of firmware from console output information output from the network device by remote management.

12. The network monitoring system according to claim 5, wherein
the management terminal comprising:
a second memory storing instructions; and
at least one second processor configured to execute the instructions to:
analyze a portion indicating an abnormality cause of the console output information in a case where the abnormality information is included in the console output information by remote management.

13. The network monitoring system according to claim 5, wherein
the management terminal comprising:
a second memory storing instructions; and
at least one second processor configured to execute the instructions to:
output the abnormality cause by remote management.
